(19) United States
(12) Patent Application Publication
(10) Pub. No.: US 2009/0199243 A1
(43) Pub. Date: Aug. 6, 2009

(54) Recommended Program Retrieval Device, and Recommended Program Retrieval Method

(75) Inventor: Takehiro Ogawa, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/273,379

(22) Filed: Nov. 18, 2008

(30) Foreign Application Priority Data
Jan. 31, 2008 (JP) 2008-022002

(51) Int. Cl. H04N 5/445; H04N 7/173

(52) U.S. Cl. 725/46; 725/134

(57) ABSTRACT

According to one embodiment, a recommended program retrieval method includes receiving a broadcast signal and demodulating the broadcast signal to output a program signal, storing program data used for creating an electronic program guide, displaying content for which a display manner is specified by a markup language configured with a plurality of tags on a display device, extracting a word from the content displayed on the display device, executing priority calculation processing for providing priority to the extracted word in accordance with a tag that designates a display manner of the word and appearance frequencies of the word, executing recommended program retrieval processing for retrieving a program including the extracted word from the program data, and executing recommendation degree calculation processing for providing a degree of recommendation to the retrieved program in accordance with priority provided to the extracted word included in the retrieved program.

### CROSS-REFERENCE TO RELATED APPLICATIONS

This application is based upon and claims the benefit of priority from Japanese Patent Application No. 2008-022002, filed Jan. 31, 2008, the entire contents of which are incorporated herein by reference.

### BACKGROUND

1. Field

One embodiment of the invention relates to a recommended program retrieval device and a recommended program retrieval method that retrieve a program to be recommended to the user depending on a web page on a network browsed by the user.

2. Description of the Related Art

In digital TV broadcasting, program arrangement information is provided together with data of a program. The program arrangement information includes information about a title of a program, broadcasting time, content, cast, and the like. In recent years, there has been provided a device that has a function of recommending a program that suits to a taste of the user by using the program arrangement information, in order to attempt promotion of viewing digital TV broadcasting.

For example, Jpn. Pat. Appln. Publication No. 2005-157690 (Paragraph [0113]) discloses a technique of retrieving and determining content to be recommended by taking out a keyword from a web page browsed by the user.

In the document described above, an interest of the user is analyzed from a character string on a browsed web page. Content displayed in the web site is tagged in HTML, and does not simply display a character string. In the prior art, a character string displayed in large size and a character string displayed in small size are equivalent. Accordingly, a characteristic of a web page that the user actually views currently cannot be expressed correctly.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the Invention.

FIG. 1 is an exemplary view showing an appearance of an information processing device as a recommended program retrieval device according to a first embodiment;

FIG. 2 is an exemplary block diagram showing a configuration of the information processing device shown in FIG. 1;

FIG. 3 is an exemplary block diagram showing a configuration of a recommended program retrieval module according to a first embodiment;

FIG. 4 is an exemplary view showing a web page displayed by a web browser;

FIG. 5 is an exemplary view showing a list of recommended programs displayed on an LCD by the recommended program retrieval module;

FIG. 6 is an exemplary block diagram showing steps of processing carried out by the recommended program retrieval module;

FIG. 7 is an exemplary block diagram showing a configuration of the recommended program retrieval module according to a second embodiment; and

FIG. 8 is an exemplary block diagram showing steps of processing carried out by the recommended program retrieval module.

### DETAILED DESCRIPTION

Various embodiments according to the invention will be described hereinafter with reference to the accompanying drawings. In general, according to one embodiment of the invention, a recommended program retrieval device, comprises a tuner configured to receive a broadcast signal and demodulate the broadcast signal to output a program signal, a storage device configured to store program data used for creating an electronic program guide, a content display module configured to display content for which a display manner is designated by a markup language configured with a plurality of tags on a display device, an extraction module configured to execute word extraction processing for extracting a word from content displayed on the display device by the content display module, a priority calculation module configured to calculate priority of the extracted word in accordance with a tag that designates a display manner of the word and appearance frequencies of the word, a program retrieval module configured to retrieve a program including the extracted word from the program data stored in the storage device, and a recommendation degree provision module configured to provide a degree of recommendation to the detected program in accordance with priority provided to the extracted word included in the retrieved program.

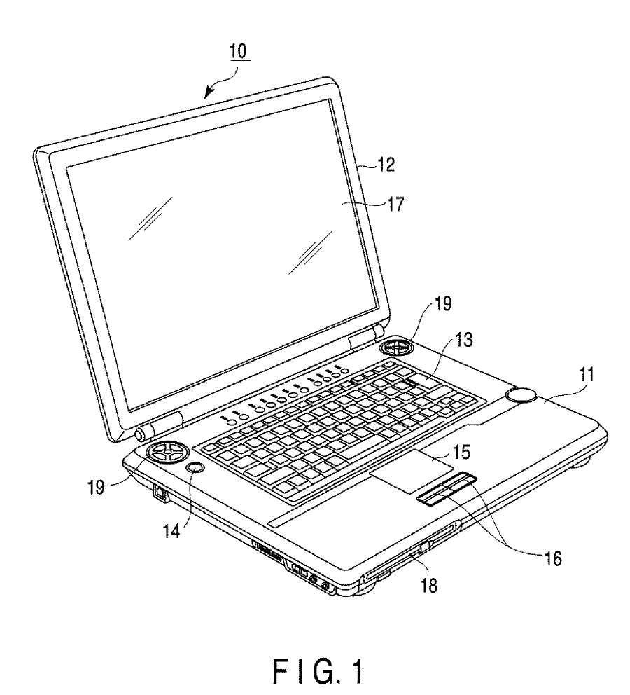

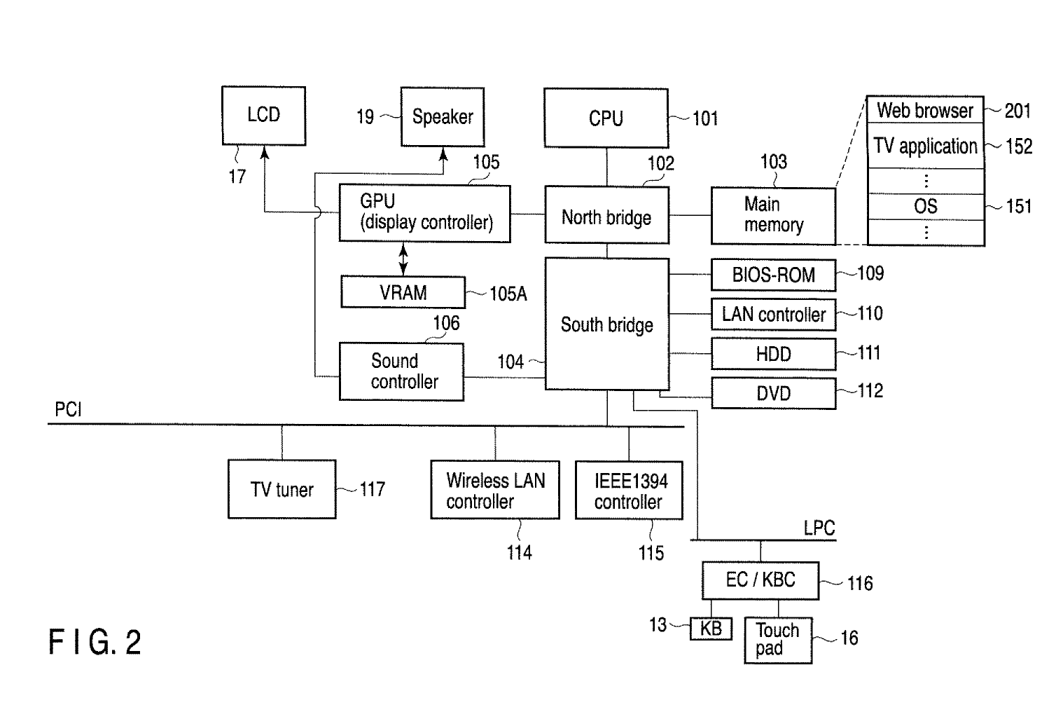

First, with reference to FIGS. 1 and 2, description will be made with respect to an information processing device that can operate as a recommended program retrieval device according to a first embodiment of the present invention. The information processing device is achieved as, for example, a notebook-type personal computer 10.

FIG. 1 is a perspective view of a state where a display unit of the notebook-type personal computer 10 is open. The present computer 10 includes a computer main body 11 and a display unit 12. The display unit 12 incorporates a display device configured with a thin film transistor liquid crystal display (TFT-LCD) 17. A display screen of the LCD 17 is positioned almost at the center of the display unit 12.

The display unit 12 is mounted to the computer main body 11 in a manner rotatable between an open position and a closed position. The computer main body 11 has a enclosure in a thin box shape. There are a keyboard 13, a power button 14 used for turning on and off the present computer 10, a touch pad 15, a touch pad control button 16, a speaker 19, and the like that are arranged on a top face of the computer main body 11.

Next, description will be made with respect to a system configuration of the present computer 10 with reference to FIG. 2.

As shown in FIG. 2, the present computer 10 includes a CPU 101, a north bridge 102, a main memory 103, a south bridge 104, a graphics processing unit (GPU) 105, a video memory (VRAM) 105A, a sound controller 106, a BIOS-ROM 109, a LAN controller 110, a hard disk drive (HDD) 111, a High-Definition Digital Versatile Disc (HD DVD)/DVD drive (ODD) 112, a card controller 113, a wireless LAN controller 114, an IEEE 1394 controller 11S, an embedded controller and keyboard controller IC (EC/KBC) 116, a TV tuner 117, and the like.

The CPU 101 is a processor that controls operation of the computer 10. The CPU 101 executes a variety of application programs, such as an operating system (OS) 151, a TV application program 152, and a web browser 201, that are loaded from the hard disk drive (HDD) 111 to the main memory 103. The TV application program 152 is software for executing a TV function. The TV application program 152 executes off-air playback processing, recording processing, reproduction processing, and the like. The off-air playback processing is for viewing broadcast program data received by the TV tuner 117. The recording processing is for recording the received broadcast program data in the HDD 111. The reproduction processing is for reproducing broadcast program data and video data recorded in the HDD 111. In addition, the CPU 101 also executes a basic input/output system (BIOS) stored in the BIOS-ROM 109. The BIOS is a program for controlling hardware.

The north bridge 102 is a bridge device that connects a local bus of the CPU 101 and the south bridge 104. The north bridge 102 includes a memory controller that access-controls the main memory 103. Also, the north bridge 102 has a function of executing communication with the GPU 105 through a serial bus complying with the PCI EXPRESS standard.

The GPU 105 is a display controller that controls the LCD 17 that is used as a display monitor of the present computer 10. A display signal generated by the CPU 105 is sent to the LCD 17. Also, the display signal may be sent out to an external TV 1 and an external HDMI monitor through respective interfaces 3 and 4 provided on the computer main body 11.

The south bridge 104 controls each device on a Low Pin Count (LPC) bus, and each device on a Peripheral Component Interconnect (PCI) bus. Also, the south bridge 104 includes an Integrated Drive Electronics (IDE) controller for controlling the HDD 111 and the ODD 112. Further, the south bridge 104 has a function of executing communication with the sound controller 106.

The sound controller 106 is a sound source device, and outputs audio data to be reproduced to the speaker 19.

The card controller 113 controls cards, such as a PC card and a Secure Digital (SD) memory card. The wireless LAN controller 114 is a wireless communication device that executes wireless communication in, for example, the IEEE 802.11 standard. The IEEE 1394 controller 115 executes communication with external equipment through a serial bus in an IEEE 1394 standard. The embedded controller and keyboard controller IC (EC/KBC) 116 is a one-chip microcomputer integrated with an embedded controller for power management, and a keyboard controller for controlling the keyboard (KB) 13 and the touch pad 15. The embedded controller and keyboard controller IC (EC/KBC) 116 has a function of turning on and off the present computer 10 in accordance with operation of the power button 14 by the user.

The TV tuner 117 is a receiving device that receives broadcast program data broadcast by means of a television (TV) broadcasting signal, and is connected to the speaker 19. The TV tuner 117 is realized as a TV tuner that can receive digital broadcasting program data such as terrestrial digital TV broadcasting. In addition, the TV tuner 117 also has a function of capturing video data input from external equipment.

The present device has a recommended program retrieval function that extracts a keyword by analyzing content displayed in the web browser 201, and retrieves broadcast content including the extracted keyword.

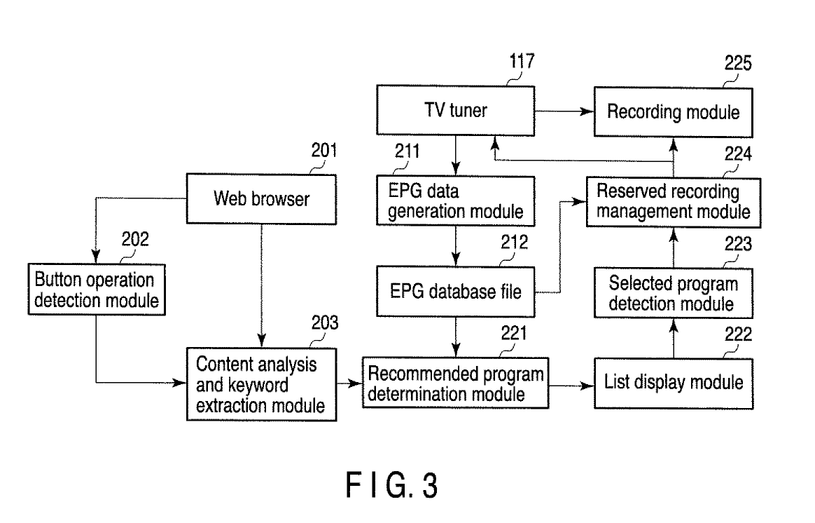

FIG. 3 shows a block diagram of a recommended program retrieval module that executes a web browser and a recommended program retrieval function.

As shown in FIG. 3, the recommended program retrieval module includes the web browser 201, a button operation detection module 202, a content analysis and keyword extraction module 203, an EPG data generation module 211, an EPG database file (program data) 212, a recommended program determination module 221, a recommended program list display module 222, a selected program detection module 223, a reserved recording management module 224, a recording module 225, and the like.

The button operation detection module 202, the content analysis and keyword extraction module 203, the recommended program determination module 221, the recommended program list display module 222, and the selected program detection module 223 are software that is executed as a plug-in of the web browser 201. In addition, the EPS data generation module 211, the reserved recording management module 224, and the recording module 225 are software that is executed as part of a function of the TV application program 152.

The EPG data generation module 211 extracts program arrangement information from a broadcasting signal output from the TV tuner 117, and builds the EPG database file 212 that serves as a basis of displaying an electronic program guide (EPG) on the basis of the program arrangement information. The EPG database file 212 is stored in the HDD 111.

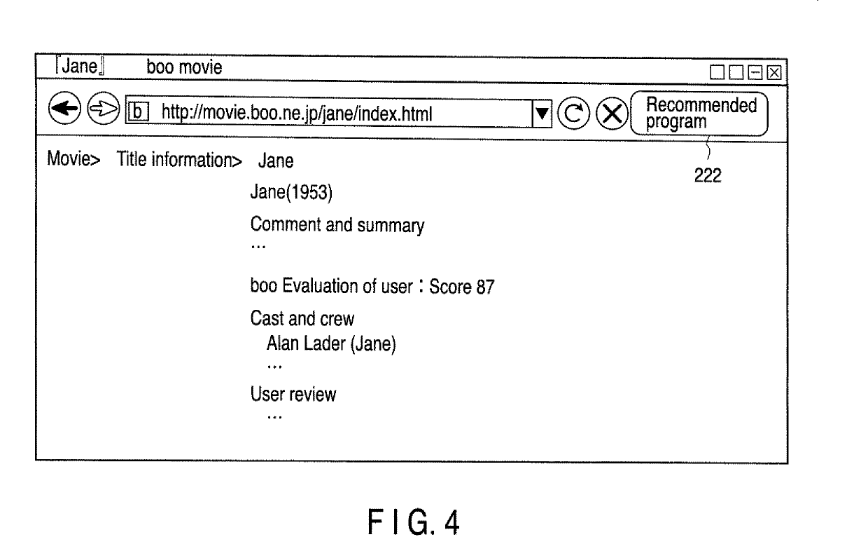

The web browser 201 is software used for browsing content (websites) on the Internet. As shown in FIG. 4, a toolbar of the web browser 201 is provided with a “Display Recommended Program” button.

The button operation detection module 202 monitors whether operation of the “Display Recommended Program” button is carried out by the user or not. When the button operation detection module 202 detects operation of the “Display Recommended Program” button, the button operation detection module 202 notifies the content analysis and keyword extraction module 203 that the button was operated, Operation of the “Display Recommended Program” button is carried out in a manner that the user places a pointer on the “Display Recommended Program” button and clicks the left button.

The content analysis and keyword extraction module 203 receiving the notice analyzes a sentence structure of content displayed by the web browser 201, extracts a keyword, and assigns priority to the extracted keyword. The content analysis and keyword extraction module 203 extracts a character string enclosed by tags (< . . . > and </ . . . >). For examples the content analysis and keyword extraction module 203 extracts a character string enclosed by tags, such as a <title> tag, <h1> to <h6> tags, an <em> tag, and a <strong> tag.

Here, <title> is a tag for adding a title to a document. A character string designated by the <title> tag is displayed on a toolbar of the browser.

Also, <h1> to <h6> are tags for adding headlines. Here, <h1> indicates a highest-order headline, and as the number becomes smaller, the level of a headline becomes lower. Accordingly, <h6> is a lowest-order headline.

Further, <em> is used to emphasize text. In a general browser, text emphasized by <em> is displayed in italics. Also, <strong> is a tag for emphasizing text more strongly than <em>. In a general browser, text emphasized by <strong> is displayed in boldface.

Then, morphological analysts is carried out with respect to the extracted character string to pick out a word that serves as a keyword.

Then, the picked-out word that serves as a keyword is weighted in accordance with appearance frequencies. Further, the picked-out word that serves as a keyword is weighted in accordance with an HTML tag in which the word is included.

Since the <title> tag is a title of a web page, priority of the <title> tag is high. Also, the <h1> tag to the <h6> tag show headlines, and priority therefor is also high. High priority is assigned to emphasizing tags, such as the <em> tag and the <strong> tag.

Then, the content analysis and keyword extraction module passes the word that serves as a keyword to the recommended program determination module 221 together with priority. The recommended program determination module 221 retrieves information (name of program, broadcasting date and time, cast) of a program including the keyword from program arrangement Information sent in a manner superimposed on a broadcast wave. Then, a degree of recommendation of an extracted program is calculated in accordance with priority of the keyword used for the retrieval.

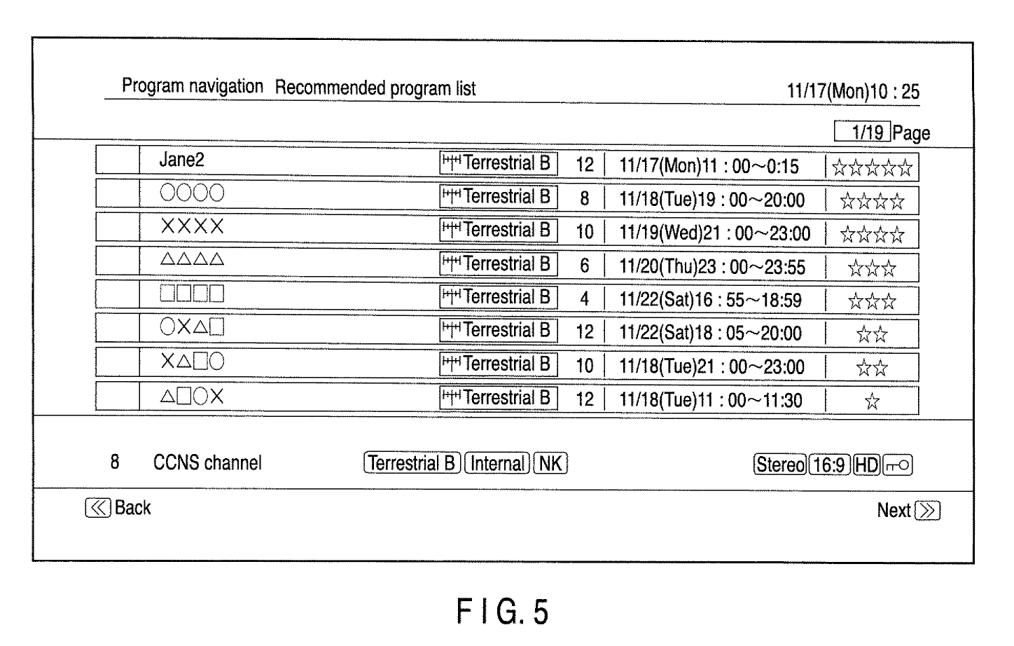

The recommended program determination module 221 passes information and a degree of recommendation of the extracted program to the recommended program list display module 222. As shown in FIG. 5, the recommended program list display module 222 displays a list of programs in the order of a program with a higher degree of recommendation. As shown in FIG. 5, a title of a program, a name of a broadcast station, broadcasting date and time, and a degree of recommendation (indicated by the number of stars) are shown with respect to each recommended program.

The selected program detection module 223 detects whether a program displayed in the list is selected by the user or not. Selection of a program by the user is carried out by placing a pointer on a section indicating information of a program and clicking the left button.

A program selected by the user from the displayed list is registered for reserved recording in the reserved recording management module 224. Then, the reserved recording management module 224 controls the TV tuner 117 and the recording module 225 to record the reserved program.

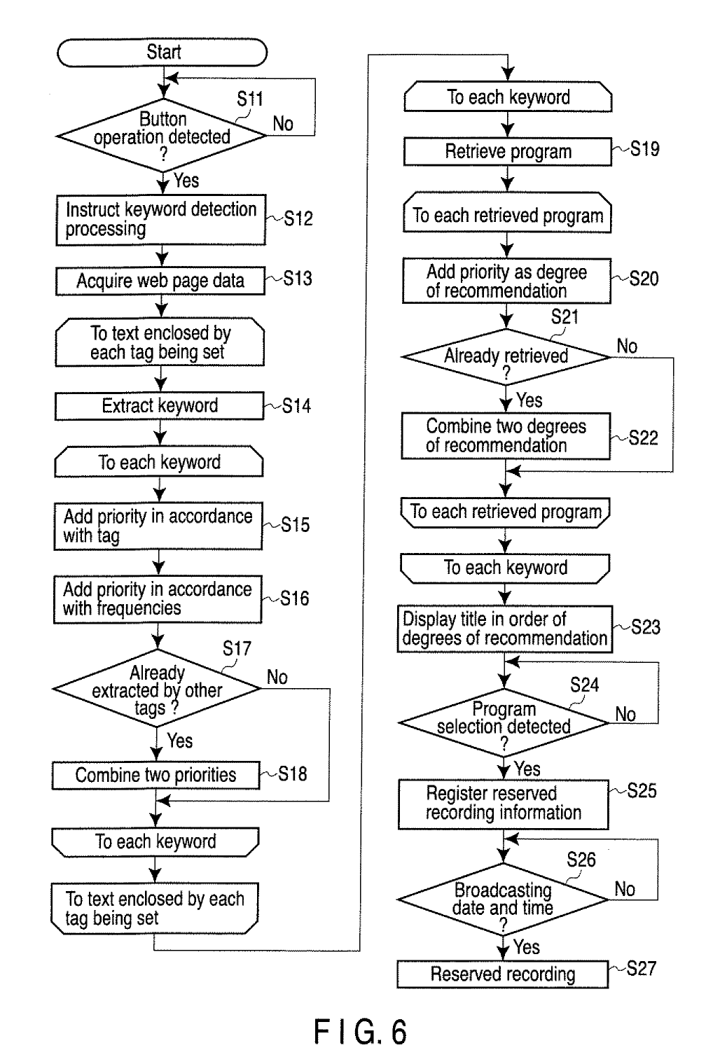

Next, steps will be described with reference to FIG. 6.

When the detection module detects that the “Display Recommended Program” button displayed in the toolbar of the web browser 201 is operated by the user (YES in block S11), start of keyword extraction processing is instructed to the content analysis and keyword extraction module 203 (block S12).

The content analysis and keyword extraction module 203 acquires data of a web page displayed by the web browser 201 (block S13). The content analysis and keyword extraction module 203 executes processing of blocks S14 to S18 with respect to text enclosed by set tags.

The content analysis and keyword extraction module 203 analyzes a sentence structure in HTML on the web page, and extracts a word that serves as a keyword by carrying out morphological analysis with respect to text enclosed by specific tags (block S14). Then, the content analysis and keyword extraction module 203 executes the processing of blocks S13 to S18 with respect to each extracted keyword.

The content analysis and keyword extraction module 203 adds priority in accordance with a tag to the extracted keyword (block S15). Moreover, the content analysis and keyword extraction module 203 further adds priority in accordance with appearance frequencies of the extracted keyword (block S16).

Then, whether a keyword for which priority is calculated has been extracted in other tags or not is discriminated (block S17). In case the keyword is determined to have been extracted (YES in block S17), the content analysis and keyword extraction module 203 combines the priority of the keyword which has already been extracted and the priority calculated in blocks S16 and S17 (block S18). In the above processing, the same keywords in duplicate are integrated into one.

When the processing of blocks S15 to S18 ends with respect to each keyword, the processing of blocks S14 to S18 is carried out to a next tag. Further, description will be made with respect to a case where the processing of blocks S14 to S18 ends for all tags being set.

The recommended program determination module 221 receives a keyword from the content analysis and keyword extraction module 203. The recommended program determination module 221 executes processing of blocks S19 to S22 with respect to each passed keyword.

The recommended program determination module 221 retrieves a program including a keyword from the EPG database file 212 with respect to each keyword (block S19). The recommended program determination module 221 executes processing of blocks S20 to S22 with respect to each of the retrieved programs.

The recommended program determination module 221 carries out calculation by using priority provided to a search keyword as a degree of recommendation (block S20). Then, the recommended program determination module 221 discriminates whether the retrieved program has been already retrieved by another keyword or not (block S21). In case the retrieved program has already been retrieved (YES in block S21), the recommended program determination module 221 adds the degree of recommendation calculated in block S21 to a degree of recommendation of the program which has already been retrieved (block S22).

When the processing of blocks S20 to S22 is complete with respect to all programs retrieved for a keyword, the processing of blocks S19 to S22 is carried out for other keywords. Then, when the processing of blocks S19 to S22 is complete for all keywords, processing of block S23 and subsequent steps is executed.

The recommended program determination module 221 passes information of an ID number on the EPS database file 212 indicating the retrieved program and a degree of recommendation to the recommended program list display module 222. The recommended program list display module 222 rearranges programs in the order of degrees of recommendation, and displays information including a title of a program broadcasting date and time, a broadcast station, and a degree of recommendation on a monitor (block S23).

The selected program detection module 223 monitors whether the user selects one program from a list of recommended programs displayed on the monitor or not (block S24). In case selection by the user is detected (YES in block S24), the selected program detection module 223 passes an ID number or the EPS database file 212 indicating a program selected by the user to the reserved recording management module 224.

The reserved recording management module 224 detects broadcasting date and time and a broadcast station by referring to the EPG database file 212 on the basis of the passed ID number, and registers information of the broadcasting date and time and the broadcast station as recording reservation information (block S25).

When broadcasting date and time registered in the recording reservation information are reached (YES in block S26), the reserved recording management module 224 controls a tuner so as to receive the broadcast station registered in the recording reservation information, and also records a program signal by controlling the recording module 225 (block S27).

In the above manner, when the user operates the “Display Recommended Program” button, recommended programs are retrieved and displayed in the order of degrees of recommendation, and reserved recording of programs selected by the user can be carried out. In the above example, an example of reserving recording is described. In addition, reservation of viewing of a program may be carried out.

The present embodiment will be summarized as described below. When the user operates the “Display Recommended Program” button, a keyword is extracted from text included in a web page. Then, a program including the keyword is retrieved from an EPG after priority in accordance with a tag and appearance frequencies is added to the keyword. A degree of recommendation corresponding to priority of the search keyword is provided to the retrieved program. Then, program titles are displayed in the order of degrees of recommendation. When the user selects a program title, reserved recording is registered and recording of the program is carried out.

### Second Embodiment

In the present embodiment, a keyword is automatically extracted from a web page viewed by the user, and priority is added in accordance with a tag and appearance frequencies. A program including the keyword is retrieved from an EPG. A degree of recommendation corresponding to priority of the search keyword is provided to the retrieved program. Then, a program with a degree of recommendation greater than or equal to a certain value is registered for reserved recording, and recording of the program is carried out.

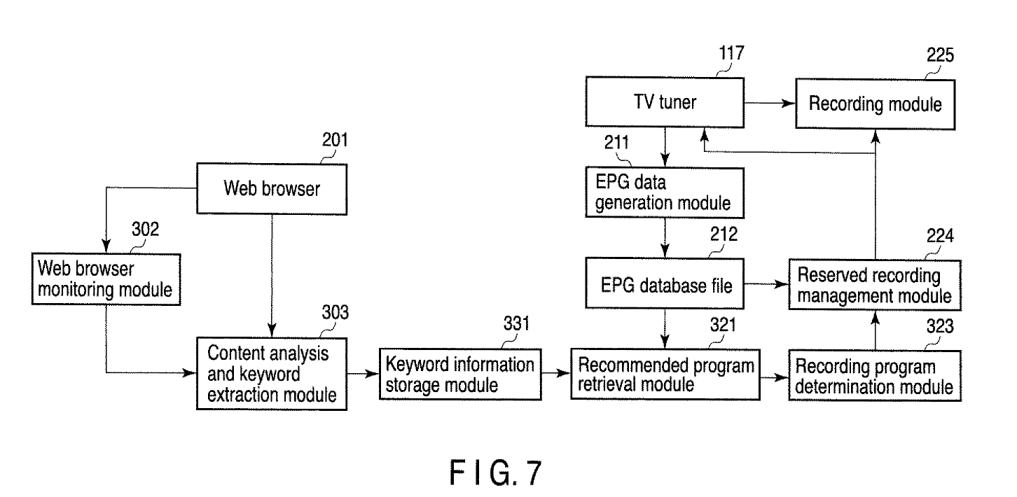

FIG. 7 is a block diagram showing configurations of a recommended program retrieval module that executes a web browser and a recommended program retrieval function and a recommended program automatic recording module, according to the second embodiment of the present invention.

As shown in FIG. 7, the second embodiment includes the web browser 201, a web browser monitoring module 302, a content analysis and keyword extraction module 303, the EPG data generation module 211, the EPG database file (program data) 212, the recommended program determination module 221, the recommended program list display module 222, the selected program detection module 223, the reserved recording management module 224, and the like.

The EPG data generation module 211 extracts program arrangement information from a broadcast signal output from the TV tuner 117, and builds the EPG database file 212 that serves as a basis of displaying an EPG on the basis of the program arrangement information. The EPG database file 212 is stored in the HDD 111.

The web browser 201 is software used for browsing content (websites) on the Internet. The web browser monitoring module 302 monitors the web browser 201. When the web browser 201 displays a new web page, the web browser monitoring module 302 notifies that fact to the content analysis and keyword extraction module 303.

When display of a new web page is notified from the web browser monitoring module 302, the content analysis and keyword extraction module 303 carries out extraction of a keyword and calculation of priority in accordance with a tag and appearance frequencies. The extraction processing of a keyword and calculation processing of priority in accordance with a tag and appearance frequencies carried out by the content analysis and keyword extraction module 303 are similar to the processing carried out by the content analysis and keyword extraction module 203 described in the first embodiment.

The content analysis and keyword extraction module 303 stores information of a keyword and priority in a keyword information storage module 331. The keyword information storage module 331 is part of an area of the HDD 111, for example.

A recommended program retrieval module 321 periodically retrieves information (name of program, broadcasting date and time, cast) of a program including the keyword from the EPG database file 212 sent in a manner superimposed on a broadcast wave. Then, a degree of recommendation of an extracted program is calculated in accordance with priority of the keyword used for the retrieval.

The recommended program retrieval module 321 passes information and a degree of recommendation of the retrieved program to a recording program determination module 322. The recording program determination module 322 determines information of a program with a degree of recommendation higher than a certain value as a program to be recorded. Then, information of the program to be recorded is passed to the reserved recording management module 224.

Information of the passed program is registered as reserved recording information in the reserved recording management module 224. Then, the reserved recording management module 224 controls the TV tuner 117 and the recording module 225 to record the reserved program in the HDD 111.

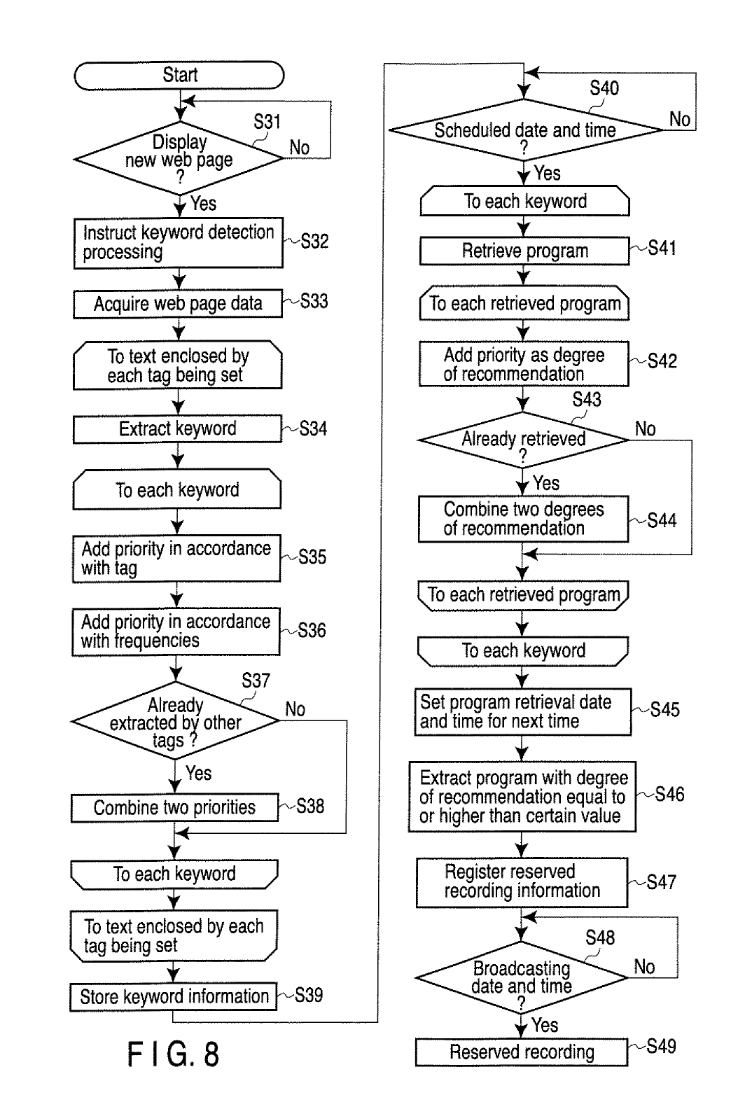

Next, steps will be described with reference to FIG. 8.

When the web browser monitoring module 302 detects that the web browser 201 displays a new web page (YES in block S31), the web browser monitoring module 302 instructs the content analysis and keyword extraction module 203 to start keyword extraction processing (block S32).

The content analysis and keyword extraction module 303 acquires data of a web page displayed by the web browser 201 (block S33). The content analysis and keyword extraction module 303 executes processing of blocks S34 to S38 with respect to text enclosed by set tags.

The content analysis and keyword extraction module 303 analyzes a sentence structure in HTML on the web page, and extracts a word that serves as a keyword by carrying out morphological analysis with respect to text enclosed by specific tags (block S34). Then, the content analysis and keyword extraction module 303 executes the processing of blocks S35 to S38 with respect to each extracted keyword.

The content analysis and keyword extraction module 303 adds priority in accordance with a tag to the extracted keyword (block S35). Moreover, the content analysis and keyword extraction module 303 further adds priority in accordance with appearance frequencies of the extracted keyword (block S36).

Then, whether a keyword for which priority is calculated has been extracted in other tags or not is discriminated (block S37) in case the keyword is determined to have been extracted (YES in block S37), the content analysis and keyword extraction module 303 combines the priority of the keyword which has already been extracted and the priority calculated in block S36 (block S38). In the above processing, the same keywords in duplicate are integrated into one.

When the processing of blocks S35 to S38 ends with respect to each keyword, the processing of blocks S14 to S18 is carried out to a next tag. When the processing of blocks S14 to S18 ends with respect to all tags being set, the content analysis and keyword extraction module 303 stores information of the extracted keyword and the priority in the keyword information storage module 331 (block S39).

When scheduled retrieval date and time retained in the inside are reached (YES in block S40), the recommended program retrieval module 321 retrieves a program to be recommended by executing processing of blocks S41 to S43.

The recommended program retrieval module 321 reads keyword information from the keyword information storage module 331. The recommended program retrieval module 321 executes processing of blocks S41 to S43 with respect to each keyword included in the read keyword information.

The recommended program retrieval module 321 retrieves a program including a keyword in the EPG database file 212 with respect to each keyword (block S41). The recommended program retrieval module 321 executes processing of blocks S42 to S44 with respect to each of the retrieved programs.

The recommended program retrieval module 321 carries out calculation by using priority provided to a search keyword as a degree of recommendation (block S42). Then, the recommended program retrieval module 321 discriminates whether the retrieved program has been already retrieved by another keyword or not (block S43). In case the retrieved program has already been retrieved (YES in block S43), the recommended program retrieval module 321 adds the degree of recommendation calculated in block S42 to a degree of recommendation of the program which has already been retrieved (block S44).

When the processing of blocks S42 to S44 has been completed with respect to all programs retrieved for a keyword, the processing of blocks S41 to S44 is carried out for other keywords. Then, when the processing of blocks S41 to S44 is complete for all keywords, processing of block S45 and subsequent steps is executed.

The recommended program retrieval module 321 updates internal setting with program retrieval date and time of a next time which is obtained by adding a certain time to program retrieval date and time set this time (block S45). By setting the program retrieval date and time for a next time, retrieval of a program is carried out periodically.

The recommended program retrieval module 321 passes information of an ID number on the EPG database file 212 indicating the retrieved program and a degree of recommendation to the recording program determination module 322. The recording program determination module 322 retrieves a program with a degree of recommendation greater than or equal to a certain value on the basis of the passed information (block S46).

The selected program detection module 223 passes an ID number on the EPG database file 212 indicating a program with a degree of recommendation greater than or equal to a certain value to the reserved recording management module 224. The reserved recording management module 224 detects broadcasting date and time and a broadcast station by referring a to the EPG database file 212 on the basis of the passed ID number, and registers information of the broadcasting date and time and the broadcast station as recording reservation information (block S47).

When broadcasting date and time registered in the recording reservation information are reached (YES in block S48), the reserved recording management module 224 controls a tuner so as to receive the broadcast station registered in the recording reservation information, and also records a program signal by controlling the recording module 225 (block S49).

In the processing described above, a keyword is automatically extracted from a web page browsed by the user, and a program in accordance with a taste of the user can be automatically recorded.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recommended program retrieval device, comprising:
a tuner configured to receive a broadcast signal and demodulate the broadcast signal to output a program signal;
a storage device configured to store program data used for creating an electronic program guide;
a content display module configured to display content for which a display manner is designated by a markup language configured with a plurality of tags on a display device;
an extraction module configured to execute word extraction processing for extracting a word from content displayed on the display device by the content display module;
a priority calculation module configured to calculate priority of the extracted word in accordance with a tag that designates a display manner of the word and appearance frequencies of the word;
a program retrieval module configured to retrieve a program including the extracted word from the program data stored in the storage device; and
a recommendation degree provision module configured to provide a degree of recommendation to the detected program in accordance with priority provided to the extracted word included in the retrieved program.

2. The recommended program retrieval device of claim 1, further comprising
a list display module configured to display a list of titles of the retrieved programs on the display device in accordance with the order of degrees of recommendation.

3. The recommended program retrieval device of claim 2, further comprising:
a selected program detection module configured to detect a program selected by the user from the displayed list of titles of the retrieved programs;
a recording unit configured to record the program signal; and
a reserved recording module configured to register reserved recording information used for reserved recording of a program detected by the selected program detection module, and control the recording unit and the tuner in order to carry out reserved recording of the detected program in accordance with the reserved recording information.

4. The recommended program retrieval device of claim 1, wherein the content display module displays an operation button that is operated by the user to start the word extraction processing, further comprising:
a button operation detection module configured to detect operation of the operation button by the user.

5. The recommended program retrieval device of claim 1, further comprising:
a recording unit configured to record the program signal; and
a reserved recording module configured to have reserved recording information used for carrying out reserved recording of a program with a degree of recommendation greater than or equal to a certain value registered therein, and control the recording unit and the tuner in order to carry out reserved recording of the program in accordance with the reserved recording information.

6. The recommended program retrieval device of claim 5, wherein the extraction of a word by the extraction module and the calculation of priority of the word by the priority calculation module are executed every time content displayed by the content display module is changed,
the device further comprises a keyword information storage unit configured to store information of the extracted word and the priority provided to the word by the priority calculation module every time the extraction of the word and the calculation of priority of the word are executed,
wherein the program retrieval module periodically retrieves a program that includes the extracted word from the program data on the basis of information stored in the keyword information storage unit.

7. A recommended program retrieval method, comprising:
receiving a broadcast signal and demodulating the broadcast signal to output a program signal;
storing program data used for creating an electronic program guide in a storage device;
displaying content for which a display manner is specified by a markup language configured with a plurality of tags on a display device;
extracting a word from the content displayed on the display device;
executing priority calculation processing for providing priority to the extracted word in accordance with a tag that designates a display manner of the word and appearance frequencies of the word;
executing recommended program retrieval processing for retrieving a program including the extracted word from the program data stored in the storage device; and
executing recommendation degree calculation processing for providing a degree of recommendation to the retrieved program in accordance with priority provided to the extracted word included in the retrieved program.

8. The recommended program retrieval method of claim 7, further comprises:
displaying a list of titles of the retrieved programs in accordance with the order of degrees of recommendation on the display device.

9. The recommended program retrieval method of claim 8, further comprises:
detecting a program selected by the user from the displayed list of titles of the retrieved programs;
registering reserved recording information used for carrying out reserved recording of the detected program in a reserved recording section that controls a recording section that records the program signal; and
controlling the recording section in accordance with the reserved recording information to carry out reserved recording of the detected program.

10. The recommended program retrieval method of claim 7, further comprises:
displaying an operation button that is operated by the user to start the word extraction processing on the display device; and
detecting operation of the operation button by the user.

11. The recommended program retrieval method of claim 7, further comprises:
a recording section configured to record the program signal;
registering reserved recording information used for carrying out reserved recording of a program with a degree of recommendation greater than or equal to a certain value in a reserved recording section that controls a recording section that records the program signal; and
controlling the recording section in accordance with the reserved recording information to carry out reserved recording of the program with a degree of recommendation greater than or equal to a certain value.

12. The recommended program retrieval method of claim 11, further comprises:
executing the word extraction processing every time content displayed on the display device is changed;
storing information of a word extracted by the word extraction processing and priority provided to the word by the priority calculation processing in a keyword information storage section each time the word extraction processing is carried out;
executing in a periodical manner the recommended program retrieval processing on the basis of the information stored in the keyword information storage section; and
executing the recommendation degree calculation processing every time the recommended program retrieval processing is carried out.
